(19) United States
(12) Patent Application Publication
(10) Pub. No.: US 2006/0003804 A1
(43) Pub. Date: Jan. 5, 2006

(54) Radio signal relaying apparatus

(75) Inventor: Huo-Pei Liu, Hsinchuang City (TW)

Correspondence Address: Troxell Law Office PLLC, Suite 1404, 5205 Leesburg Pike, Falls Church, VA, 22041, US

(73) Assignee: Unication Co., Ltd.

(21) Appl. No.: 10/852,175

(22) Filed: May 25, 2004

(51) Int. Cl. H04B 1/38

(52) U.S. Cl. 455/557; 455/559

(57) ABSTRACT

A radio signal relaying device has a PDA and a wireless modulating module connected to the PDA. The PDA is provided with multiple ports of different specifications such as a memory card slot, a USB interface or a serial port. The wireless modulating module is selectively linked to one of the ports to modulate music files stored in the PDA. The modulated sound files can be transmitted in the form of radio waves and then be demodulated and played by any radio receiving device.

### BACKGROUND OF THE INVENTION

1. Field of Invention The present invention relates to a radio signal relaying apparatus, and more particularly to a signal relaying apparatus that utilizes a multi-interface personal digital assistant (PDA) to relay radio signals, whereby any radio receiving device is able to be used as the output device for the relayed radio signals.

2. Related Art

With the advantages of small size, high capacity, powerful management capabilities, etc., the personal digital assistant (PDA) has been widely applied in routine works management. To cater for consumers' requirements, many useful functions, such as wireless access to the Internet, have also been integrated into the PDA.

Although many functions have been integrated into the PDA, the ability to play sounds is still inconvenient and needs to be improved. Now, the PDA can easily download a music file, such as an MP3 file, from an Internet website using a wireless Internet accessing technique. Thereafter, a music play program stored in the PDA can manage and play the stored music files. However, when the user wants to listen to the music file, an additional audio accessory such as earphones and/or a speaker is required to electrically connect to the PDA.

However, such use of additional audio output apparatus is inconvenient in particular situations. For example, when the user is driving a car, the use of earphones is inconvenient and may be prohibited.

To overcome the shortcomings, a broadcasting apparatus in accordance with the present invention obviates or mitigates the aforementioned drawbacks.

### SUMMARY OF THE INVENTION

The primary objective of the present invention is to provide a radio signal relay apparatus to relay modulated music files, whereby any radio receiving apparatus is able to receive the relayed music files and then broadcast them.

To achieve the objective of the present invention, the apparatus comprises a personal digital assistant (PDA) with multiple ports of different specifications, wherein the PDA stores music files and a music play program therein, wherein the music play programs selects the music files to be broadcast and sets a broadcast frequency; and a wireless modulating module, which connects to a selected port among the multiple ports of the PDA and modulates the selected music files to become radio signals at the set frequency, wherein the radio signals are further transmitted by the wireless modulating module.

Other objectives, advantages and novel features of the invention will become more apparent from the following detailed description when taken in conjunction with the accompanying drawings.

### BRIEF DESCRIPTION OF THE DRAWINGS

FIG. 1 is a schematic diagram of equipment needed to implement a broadcasting method in accordance with the present invention; and

FIG. 2 is a functional block diagram of a broadcasting apparatus according to a first embodiment of the present invention;

FIG. 3 is a functional block diagram of a broadcasting apparatus according to a second embodiment of the present invention;

FIG. 4 is a functional block diagram of a broadcasting apparatus according to a third embodiment of the present invention;

FIG. 5 is a functional block diagram of a broadcasting apparatus according to a fourth embodiment of the present invention; and

FIG. 6 is a functional block diagram of a broadcasting apparatus according to a fifth embodiment of the present invention.

### DETAILED DESCRIPTION OF THE INVENTION

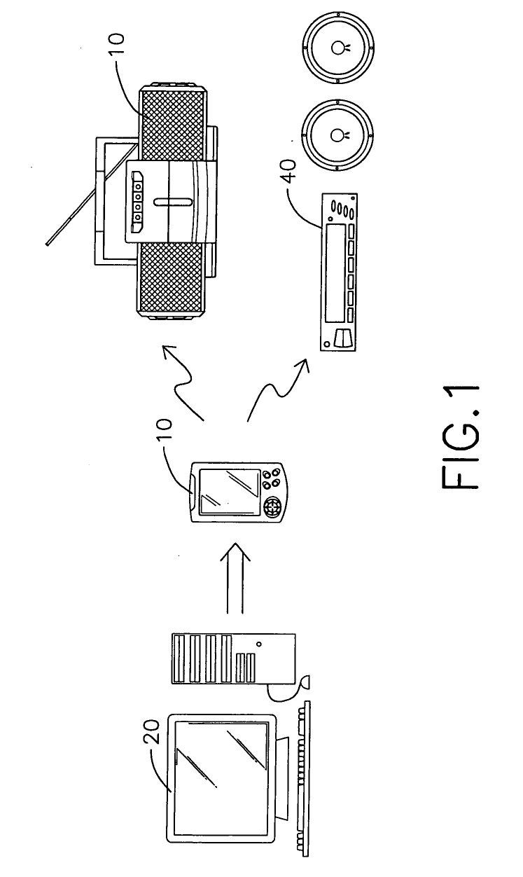

With reference to FIG. 1, as an example, a personal digital assistant (PDA)(10) in accordance with the present invention is used as a radio signal relaying device. Music files of MP3 or WAV formats are stored in the PDA (10). These music files can be accessed from a personal computer (20), an Internet website, a memory card etc. A music playing software (program) resident in the PDA (10) is used to choose the music files to be broadcast in the form of radio signals and to set a desired frequency.

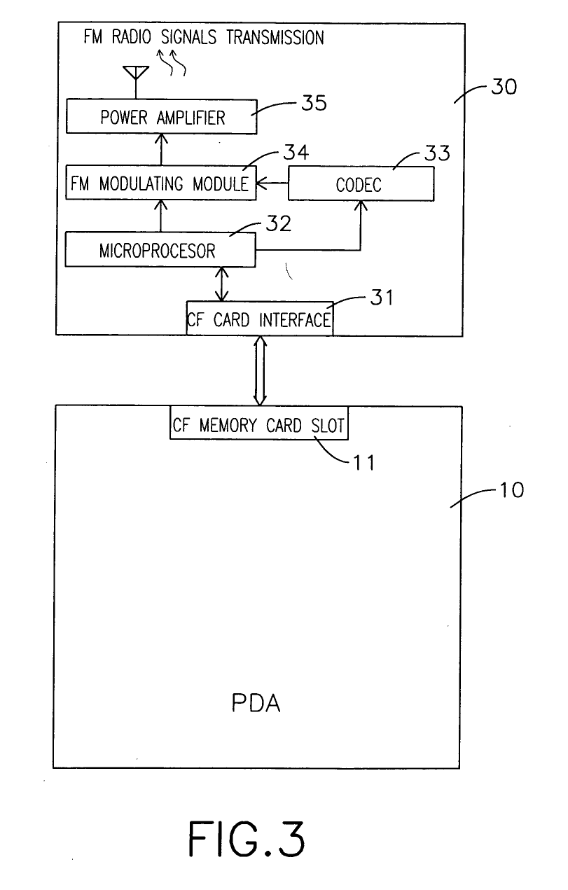

The PDA (10) is equipped with multiple ports of different specifications, for example a USB port, a serial port, a CF (Compact Flash) memory card slot, a SD (Secure Digital) memory card slot or other memory card slots. In the present invention any foregoing port is chosen to connect to a wireless modulating module (shown in FIGS. 3 to 6). The wireless modulating module is used to set a desired frequency value as the frequency of a carry wave when transmitting radio signals. The chosen music files are processed by the modulating module to become radio signals and then are transmitted. Any radio receiving device (40), for example a portable radio or a vehicle radio, within the effective region of the modulating module is able to receive the radio signals from the PDA (10), demodulate and play the radio signal.

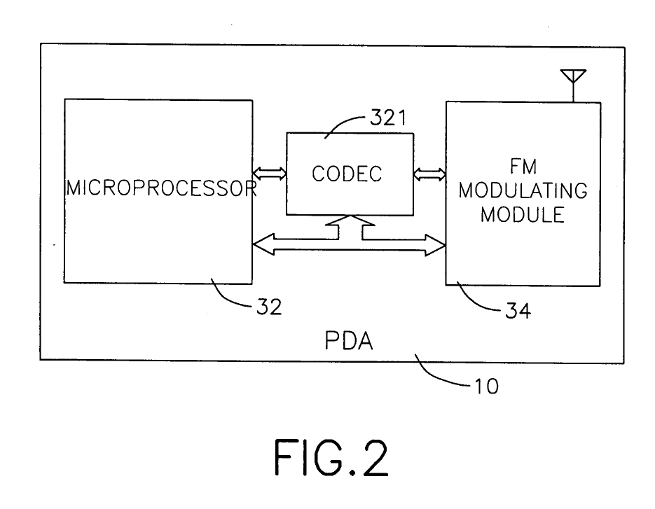

With reference to FIG. 2, a first embodiment of the present invention is implemented by the PDA (10) having a microprocessor (32), an FM modulating module (34) and a coder-decoder (CODEC) (321) connected between the microprocessor (32) and the FM modulating module (34). The music files stored in the PDA are digitized data. Therefore before transmitting the music files, the microprocessor (32) firstly retrieves the music files and outputs these files to the CODEC (321). The CODEC (321) then converts the digital data to analog format and sends the analog data to the FM modulating module (34). Based on the set frequency value, the microprocessor (32) controls the FM modulating module (34) to modulate the analog data to become radio signals and to transmit the radio signals thus allowing the radio receiving device (40) to receive and play the radio signals.

With reference to FIG. 3, a second embodiment of the present invention comprises a PDA (10) having a CF memory card slot (11) and a wireless modulating module (30) electrically connected to the CF memory card slot (11). The wireless modulating module (30) comprises a linking interface such as a CF card interface (31), a microprocessor (32), a CODEC (33), an FM modulating module (34) and a power amplifier (35). The CF card interface (31) correspondingly connects to the CF memory card slot (11). The microprocessor (32), which is connected to FM modulating module (34) and the CODEC (33), retrieves the digital music files from the PDA (10) through the CF card interface (31) and obtains the set frequency parameter that applies for signal modulating. The CODEC (33) receives the digital music files from the microprocessor (33) and converts the files to analog data. The analog data is further output to the FM modulating module (34). The FM modulating module (34) modulates the analog data with the set frequency. The modulated analog data, i.e. the radio signals, are amplified by the power amplifier (35) and transmitted wirelessly.

In this embodiment, the appearance of the wireless modulating module (30) is preferably constructed like a CF memory card so that when connecting to the PDA (30), the wireless modulating module (30) can be completely inserted into the CF memory card slot (11). This is particularly useful for users who carry the PDA (10), because there is almost no change in the entire volume of the PDA (10).

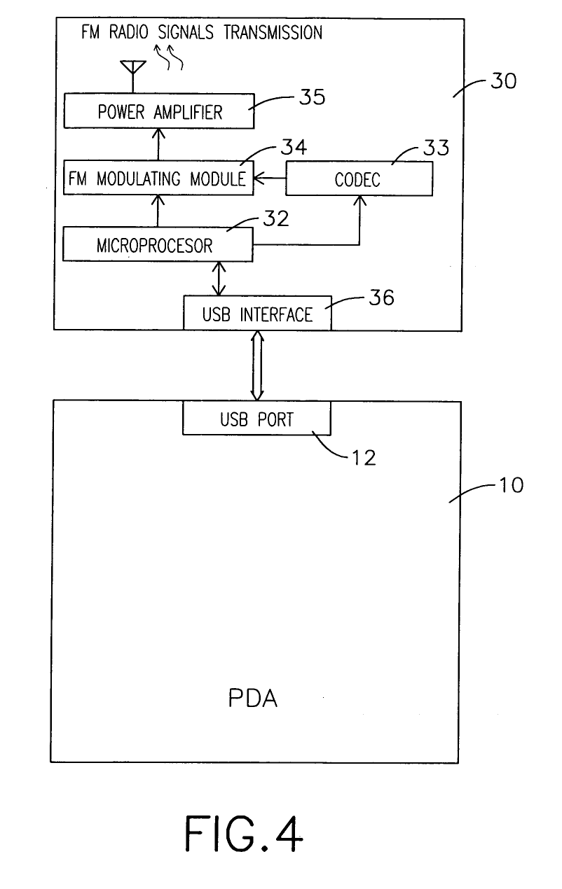

With reference to FIG. 4, the third embodiment of the present invention is substantially the same as that of FIG. 3. A change made to the embodiment is that the PDA (10) uses a USB port (12) to electrically connect to the wireless modulating module (30). Accordingly, the wireless modulating module (30) forms a USB interface (36) that is preferably made like a USB connector to correspondingly connect to the USB port (12).

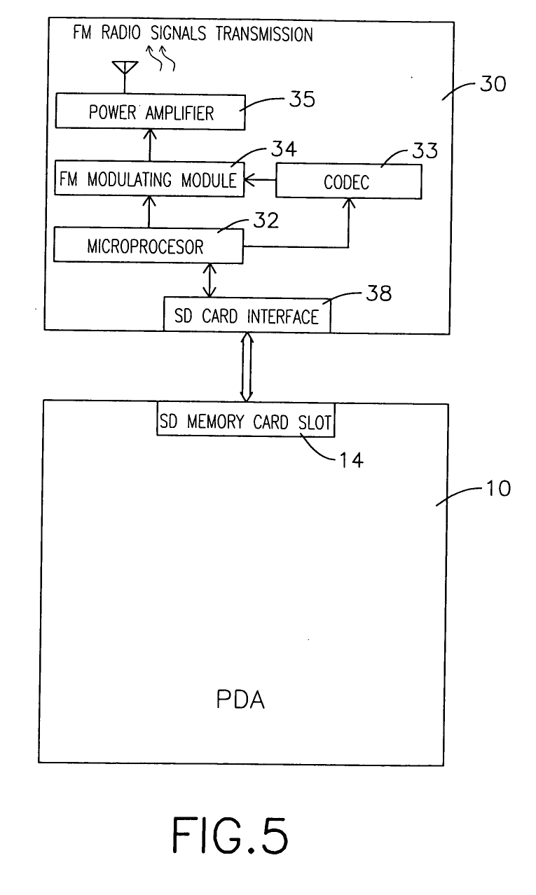

Yet another embodiment is shown in FIG. 5, wherein the PDA (10) provides an SD memory card slot (14) to electrically link to an SD card interface (38) of the wireless modulating module (30). Similarly, the appearance of the wireless modulating module (30) is preferably constructed like an SD memory card.

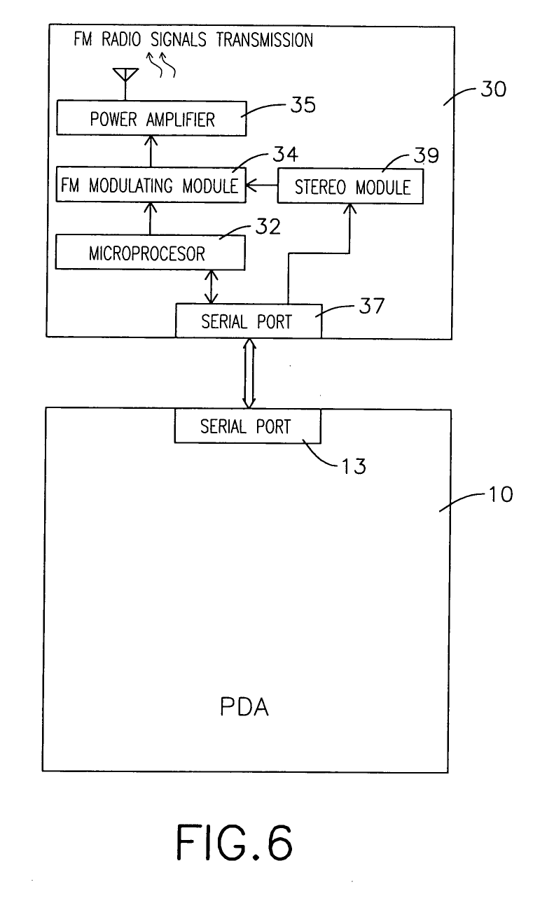

With reference to FIG. 6, the PDA (10) uses a serial port (13) to electrically connect to a serial port (37) of the wireless modulating module (30). The serial ports (13)(37) could be any known standard, such as the RS-232 communication protocol. It is noted that since the music files output from the PDA (10) are in analog format, there is no need to use the CODEC (33). A stereo module (39) connected to the serial port (37) is optionally adopted to improve audio quality. The modified analog data is then output to the FM modulating module (34).

Through the present invention, any sound file stored in the PDA can be broadcast to any radio receiving device within the effective region of the PDA. Therefore, the audio output device does not have to be connected physically to the PDA anymore. For example, when a driver uses the PDA to broadcast the music files in the PDA, the vehicle radio can directly play music since the vehicle radio is the most convenient music playing device in this situation. Moreover, when in use, the PDA may be operated in all kinds of situations depend on users' requirements. The wireless modulating module of the present invention, without connecting additional power wires or signal wires, makes the PDA become more suitable to operate in company with a radio device.

The invention may be varied in many ways by a skilled person in the art. Such variations are not to be regarded as a departure from the spirit and scope of the invention, and all such modifications are intended to be included within the scope of the following claims.

What is claimed is:

1. A radio signal relaying apparatus comprising:
a personal digital assistant (PDA) with multiple ports of different specifications, wherein the PDA stores music files and a music play program therein, wherein the music play programs selects the music files to be broadcast and sets a broadcast frequency; and
a wireless modulating module, which connects to a selected port among the multiple ports of the PDA and modulates the selected music files to become radio signals at the set frequency, wherein the radio signals are further transmitted by the wireless modulating module.

2. The radio signal relaying device as claimed in claim 1, the wireless modulating module comprising:
a linking interface correspondingly connected to the selected port of the PDA;
a microprocessor, which connects to the linking interface and retrieves the set broadcast frequency and the music files from the PDA;
a coder-decoder(CODEC) connected to the microprocessor to receive the music files and convert the music files into analog data;
an FM modulating module connected to the microprocessor and the CODEC, wherein the FM modulating module modulates the selected music files to become radio signals at the set broadcast frequency; and
a power amplifier connected to the FM modulating module to transmit the radio signals.

3. The radio signal relaying device as claimed in claim 2, wherein the linking interface is a CF memory card interface, and the selected port of the PDA for connection to the CF memory card interface is a CF memory card slot.

4. The radio signal relaying device as claimed in claim 2, wherein the linking interface is a USB interface, and the selected port of the PDA for connection to the USB interface is a USB port.

5. The radio signal relaying device as claimed in claim 2, wherein the linking interface is an SD memory card interface, and the selected port of the PDA for connection to the CF memory card interface is an SD memory card slot.

6. The radio signal relaying device as claimed in claim 1, the wireless modulating module comprising:
a serial port that correspondingly connects to a serial port of the PDA;
a microprocessor, which connects to the serial port of the wireless modulating module and retrieves the set broadcast frequency from the PDA;
a stereo module connected to the serial port of the wireless modulating module to retrieve the music files of analog format for improving audio quality;
an FM modulating module connected to the microprocessor and the stereo module, wherein the FM modulating module modulates the selected music files to become radio signals at the set broadcast frequency; and
a power amplifier connected to the FM modulating module to transmit the radio signals.

7. The radio signal relay device as claimed in claim 1 further comprising a radio receiving device to demodulate the transmitted radio signals from the wireless modulating device and to play the music files.

8. The radio signal relay device as claimed in claim 2 further comprising a radio receiving device to demodulate the transmitted radio signals from the wireless modulating device and to play the music files.

9. The radio signal relay device as claimed in claim 3 further comprising a radio receiving device to demodulate the transmitted radio signals from the wireless modulating device and to play the music files.

10. The radio signal relay device as claimed in claim 4 further comprising a radio receiving device to demodulate the transmitted radio signals from the wireless modulating device and to play the music files.

11. The radio signal relay device as claimed in claim 5 further comprising a radio receiving device to demodulate the transmitted radio signals from the wireless modulating device and to play the music files.

12. The radio signal relay device as claimed in claim 6 further comprising a radio receiving device to demodulate the transmitted radio signals from the wireless modulating device and to play the music files.

13. The radio signal relay device as claimed in claim 7, wherein the radio receiving device is a portable radio.

14. The radio signal relay device as claimed in claim 8, wherein the radio receiving device is a portable radio.

15. The radio signal relay device as claimed in claim 9, wherein the radio receiving device is a portable radio.

16. The radio signal relay device as claimed in claim 10, wherein the radio receiving device is a portable radio.

17. The radio signal relay device as claimed in claim 11, wherein the radio receiving device is a portable radio.

18. The radio signal relay device as claimed in claim 12, wherein the radio receiving device is a portable radio.

19. A personal digital assistant (PDA) equipped with a microprocessor and a CODEC and stored music files therein, wherein the improvement comprises:
an FM modulating module equipped in the PDA and connected to the microprocessor and the CODEC, wherein the music files stored in the PDA are firstly converted to analog data by the CODEC and then output to the FM modulating module so that the FM modulating module is able to modulate the analog data to become radio signals at a broadcast frequency set by the microprocessor.
